(19) United States
(12) Patent Application Publication
(10) Pub. No.: US 2026/0197793 A1
(43) Pub. Date: Jul. 9, 2026

(54) USER EQUIPMENT AND METHOD FOR POSITIONING REFERENCE SIGNAL PROCESSING

(71) Applicant: SAMSUNG ELECTRONICS CO., LTD., Suwon-si (KR)

(72) Inventors: Yejin LEE, Suwon-si (KR); Jungho SO, Suwon-si (KR)

(73) Assignee: SAMSUNG ELECTRONICS CO., LTD., Suwon-si (KR)

(21) Appl. No.: 19/438,190

(22) Filed: Dec. 31, 2025

(30) Foreign Application Priority Data
Jan. 3, 2025 (KR) 10-2025-0001204
Apr. 11, 2025 (KR) 10-2025-0047688

(51) Int. Cl. H04W 64/00; H04L 5/00; H04L 27/26

(52) U.S. Cl. CPC H04W 64/00; H04L 5/0098; H04L 27/265

(57) ABSTRACT

A operation method of a user equipment that performs wireless communication with a first base station includes receiving a Positioning Protocol (PP) message from the first base station through signaling, receiving, based on the PP message, a Positioning Reference Signal (PRS) of the first base station from the first base station at a first timing and a PRS of a second base station that is adjacent to the first base station, generating first data by performing a circular shift operation that changes a starting position of PRS data of the PRS of the second base station, to the first timing, and measuring a Reference Signal Time Difference (RSTD) based on the PRS of the first base station and the first data. The first timing is a timing at which the PRS of the first base station arrives at the user equipment.

### CROSS-REFERENCE TO RELATED APPLICATION

This application is based on and claims priority under 35 U.S.C. § 119 to Korean Patent Application No. 10-2025-0001204, filed on Jan. 3, 2025, and to Korean Patent Application No. 10-2025-0047688, filed on Apr. 11, 2025, in the Korean Intellectual Property Office, the disclosures of each of which being incorporated by reference herein in their entireties.

### BACKGROUND

The present disclosure relates to wireless communication, and more particularly, to a user equipment configured to perform an operation of estimating a position of the user equipment based on a Positioning Reference Signal (PRS) and an operation method of the user equipment.

To estimate positions of user equipment, various positioning techniques may include Downlink-Time Difference of Arrival (DL-TDoA) that is a technique based on time, Downlink-Angle of Departure (DL-AoD) that is a technique based on angles, and the like.

In particular, in DL-TDoA, a user equipment may measure a reference signal time difference (RSTD), which is the difference between times at which downlink-positioning reference signals (DL-PRSs) transmitted by base stations of different cells that are adjacent to each other have arrived at the user equipment, and may report the RSTD to a base station. The base station may estimate the position of the user equipment based on the RSTD. When the RSTD is measured, a Positioning Reference Signal (PRS) of a base station relatively farther from a user equipment, among base stations of different cells adjacent to each other, may suffer from interference due to the difference in signal arrival timing from a PRS of a base station (for example, a serving cell) which performs wireless communication, and it may be difficult to measure the accurate RSTD due to the interference. In addition, when a timing of receiving a PRS is changed to remove interference, the performance of interpolation for the PRS may deteriorate due to a change in phase.

### SUMMARY

It is an aspect to provide a user equipment capable of estimating the position of the user equipment so as to adjust a timing of receiving a Positioning Reference Signal (PRS), remove interference by performing a circular shift operation, and prevent the performance deterioration of interpolation for the PRS, and an operation method of the user equipment.

According to an aspect of one or more embodiments, there is provided an operation method of a user equipment configured to perform wireless communication with a first base station, the operation method comprising receiving a Positioning Protocol (PP) message from the first base station through signaling; receiving, based on the PP message, a Positioning Reference Signal (PRS) of the first base station from the first base station at a first timing and a PRS of a second base station that is adjacent to the first base station; generating first data by performing a circular shift operation that changes a starting position of PRS data of the PRS of the second base station, to the first timing; and measuring a Reference Signal Time Difference (RSTD) based on the PRS of the first base station and the first data. The first timing is a timing at which the PRS of the first base station arrives at the user equipment.

According to another aspect of one or more embodiments, there is provided a user equipment configured to perform wireless communication with a first base station, the user equipment comprising a plurality of antennas configured to receive a Positioning Protocol (PP) message from the first base station through signaling; and a communication processor configured to measure a Reference Signal Time Difference (RSTD) based on the PP message. The communication processor is further configured to when operating in a first mode, receive a Positioning Reference Signal (PRS) of the first base station at a first timing that is a timing at which the PRS of the first base station arrives at the user equipment, and a PRS of a second base station that is adjacent to the first base station; generate first data by performing a circular shift operation that changes a starting position of PRS data of the PRS of the second base station to the first timing; and measure the RSTD based on the PRS of the first base station and the first data; and when operating in a second mode, receive the PRS of the first base station at the first timing, receive the PRS of the second base station at a second timing at which the PRS of the second base station arrives at the user equipment, and measure the RSTD based on the PRS of the first base station and the PRS of the second base station.

According to yet another aspect of one or more embodiments, there is provided a user equipment configured to perform wireless communication with a first base station, the user equipment comprising a plurality of antennas configured to receive a Positioning Protocol (PP) message from the first base station through signaling; and a communication processor configured to measure a Reference Signal Time Difference (RSTD) based on the PP message. The communication processor is further configured to receive, based on the PP message, a Positioning Reference Signal (PRS) of the first base station at a first timing and a PRS of a second base station adjacent to the first base station; generate first data by performing a circular shift operation that changes a starting position of PRS data of the PRS of the second base station to the first timing; and measure the RSTD based on the PRS of the first base station and the first data. The first timing is a timing at which the PRS of the first base station arrives at the user equipment.

### BRIEF DESCRIPTION OF THE DRAWINGS

Brief descriptions of respective drawings are provided to gain a sufficient understanding of the drawings of the detailed description. Various embodiments will be more clearly understood from the following detailed description taken in conjunction with the accompanying drawings, in which:

FIG. 1 is a block diagram illustrating a wireless communication system according to some embodiments;

FIG. 2 is a diagram illustrating a timing for a user equipment to receive a Positioning Reference Signal (PRS), according to an embodiment;

FIG. 3 is a flowchart illustrating an operation method of a user equipment, according to an embodiment;

FIG. 4 is a diagram illustrating a circular shift operation of a user equipment, according to an embodiment;

FIG. 5 is a flowchart illustrating an operation method of a user equipment, according to an embodiment;

FIG. 6 is a diagram illustrating interpolation performed on a PRS by a user equipment, according to an embodiment;

FIG. 7 is a flowchart illustrating an operation method of a user equipment, according to an embodiment;

FIGS. 8 to 10 are diagrams illustrating a second operation of a user equipment, according to an embodiment;

FIG. 11 is a block diagram illustrating a user equipment according to an embodiment;

FIG. 12 is a flowchart illustrating an operation method of a wireless communication system, according to an embodiment;

FIG. 13 is a block diagram illustrating an electronic device according to an embodiment; and

FIG. 14 is a conceptual diagram illustrating an Internet-of-Things (IOT) network system to which an embodiment is applied.

### DETAILED DESCRIPTION

Hereinafter, various embodiments are described in accordance with long-term evolution (LTE) network-based wireless communication systems, particularly, 3GPP. However, embodiments are not limited thereto to LTE networks and may be applied to any other wireless communication systems (for example, cellular communication systems, such as new radio (NR) systems, LTE-advanced (LTE-A) systems, wireless broadband (WiBro) systems, global system for mobile communication (GSM) systems, or next-generation (for example, 6G or the like) communication systems, or short-range communication systems, such as Bluetooth systems and near-field communication (NFC) systems), which have technical backgrounds or channel setting similar to LTE systems.

In addition, various functions described below may be implemented or supported by artificial intelligence technology or by one or more computer programs. Each of the one or more computer programs may include computer-readable program code and may be implemented on a computer-readable medium. The terms “application” and “program” refer to one or more computer programs, software components, instruction sets, procedures, functions, objects, classes, instances, related data, or portions thereof suitable for the implementation of suitable computer-readable program code. The term “computer-readable program code” includes any types of computer code including source code, object code, and execution code. The term “computer-readable medium” includes any types of media, such as read-only memory (ROM), random access memory (RAM), hard disk drives, compact discs (CDs), digital video disks (DVDs), or any other types of memory, which may be accessed by computers. A “non-transitory” computer-readable medium does not include wired, wireless, optical, or other communication links for transmitting temporary electrical or other signals. The non-transitory computer-readable medium includes media in which data may be permanently stored, and media in which data may be stored and overwritten afterward, such as rewritable optical disks or erasable memory devices.

In embodiments described below, a hardware approach is described as an example. However, because embodiments include a technique using both hardware and software, the embodiments do not exclude software-based approaches.

Hereinafter, various embodiments will be described in detail with reference to the accompanying drawings.

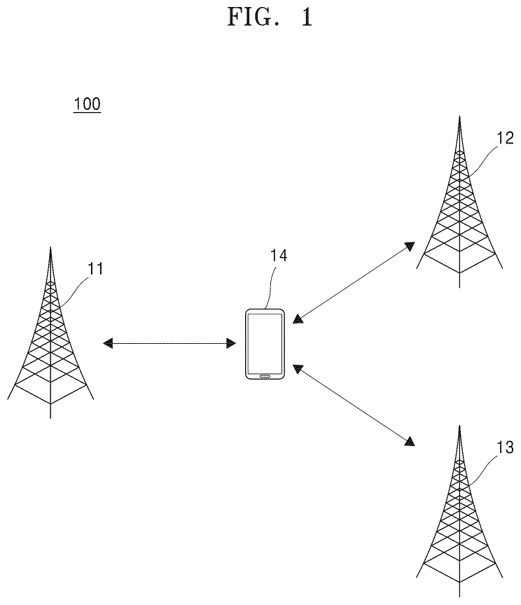

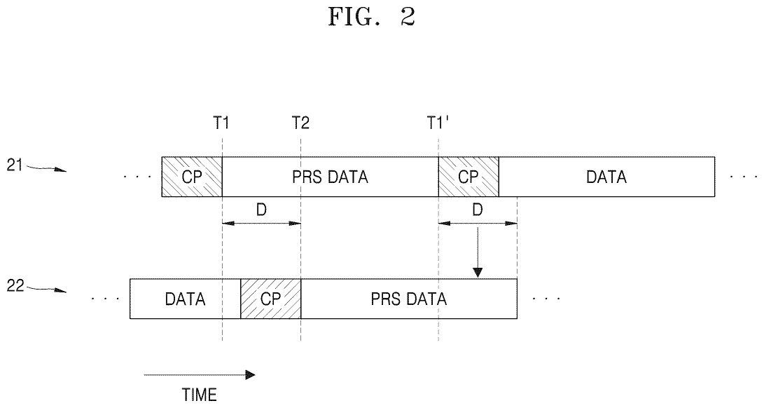

FIG. 1 is a block diagram illustrating a wireless communication system according to some embodiments. FIG. 2 is a diagram illustrating a timing for a user equipment to receive a Positioning Reference Signal (PRS), according to an embodiment.

Referring to FIG. 1, a wireless communication system 100 may include a first base station 11, a second base station 12, and a third base station 13 and a user equipment 14. Each of the first, second, and third base stations 11, 12, and 13 may generally refer to a fixed station communicating with the user equipment 14 and other base stations (not shown) or may refer to a satellite (for example, one of a geostationary orbit (GEO) satellite and a low-earth orbit (LEO) satellite) that is mobile and communicates with the user equipment 14 and other base stations (not shown). For example, a base station 11 may support a non-terrestrial network and a terrestrial network.

The first, second, and third base stations 11, 12, and 13 may exchange data and control information with the user equipment 14 and other base stations (not shown) by communicating with the user equipment 14 and the other base stations (not shown). For example, each of the first, second, and third base stations 11, 12, and 13 may be referred to as a transmission and reception point (TRP), a cell, a Node B, an evolved-Node B (eNB), a next-generation Node B (gNB), a sector, a site, a base transceiver system (BTS), an access point (AP), a relay node, a remote radio head (RRH), a radio unit (RU), a small cell, a device, or the like. Each of the first, second, and third base stations 11, 12, and 13 may provide wireless broadband access to the user equipment 14 within the coverage thereof.

The user equipment 14 may refer to any equipment that is stationary or mobile and may transmit data or control information to and receive data or control information from the first, second, and third base stations (that is, 11, 12, and 13) by communicating with the first, second, and third base stations 11, 12, and 13. For example, the user equipment 14 may be referred to as a terminal, a terminal equipment, a mobile station (MS), a mobile terminal (MT), a user terminal (UT), a subscribe station (SS), a wireless communication device, a wireless device, a handheld device, or the like. Although only one of the user equipment 14 is illustrated, embodiments are not limited thereto. For example, the wireless communication system 100 may further include other user equipment (not shown) in addition to the user equipment 14.

The wireless communication system 100 may perform a positioning operation that is an operation of estimating the position of the user equipment 14. The wireless communication system 100 may perform a positioning operation by using an Observed Time Difference of Arrival (OTDoA) technique. The OTDoA technique may refer to a technique of measuring times for PRSs simultaneously transmitted by several base stations to arrive at the user equipment 14, and then estimating the position of the user equipment 14 according to geometric triangulation or similar principle thereto based on a Reference Signal Time Difference (RSTD) that refers to the difference between arrival times of the PRSs. A PRS may refer to a reference signal used to estimate the position of the user equipment. The user equipment 14 may receive a plurality of PRSs transmitted by different ones of the first, second, and third base stations (that is, 11, 12, and 13) that are adjacent to each other and may measure an RSTD based on the plurality of PRSs that are received. Here, adjacent to each other may mean that the first, second, and third base stations 11, 12, and 13 are in (or are serving) cells that border each other. The user equipment 14 may receive a PRS through a resource block (RB) of a downlink subframe determined for PRS transmission. The user equipment 14 may transmit the RSTD to a location management function (LMF) (for example, a location server) that refers to a network for estimating the position of the user equipment 14 in the wireless communication system 100, and the LMF (for example, a location server) may estimate the position of the user equipment 14 based on the RSTD.

For example, the user equipment 14 may perform wireless communication with the first base station 11, and the wireless communication system 100 may perform a positioning operation by using the OTDoA technique. The user equipment 14 may receive the PRS of each of the first base station 11 and the second base station 12. When the distance between the second base station 12 and the user equipment 14 is relatively greater than the distance between the first base station 11 and the user equipment 14, the time for the PRS of the second base station 12 to arrive at the user equipment 14 may be delayed, the PRS of the second base station 12 may undergo interference due to a signal (for example, a Cell-specific Reference Signal (CRS)) of the first base station 11.

For example, referring further to FIG. 2, a first signal 21 may refer to a signal of the first base station 11, which is received by the user equipment 14, and a second signal 22 may refer to a signal of the second base station 12, which is received by the user equipment 14. The horizontal axis in the first signal 21 and the second signal 22 may represent time. Each of the first signal 21 and the second signal 22 may include a cyclic prefix CP, PRS data, and other signal data (that is, Data). The other signal data may include, for example, a CRS, a Physical Downlink Control Channel (PDCCH), and the like, other than the PRS data. When the distance between the second base station 12 and the user equipment 14 is relatively greater than the distance between the first base station 11 and the user equipment 14, the PRS data of the second signal 22 may arrive at the user equipment 14 at a second timing T2 that is delayed from a first timing T1 by as much as a delayed interval D, and the PRS data of the second signal 22 as much as the delayed interval D may undergo interference due to the CP or the other signal data (that is, Data) of the first signal 21.

Although the wireless communication system 100 may receive a plurality of PRSs at the same timing to reduce an influence of the interference of a serving cell signal, the PRS data may have a phase change in correspondence with the delayed interval D, and the wireless communication system 100 may not measure an accurate RSTD due to the phase change.

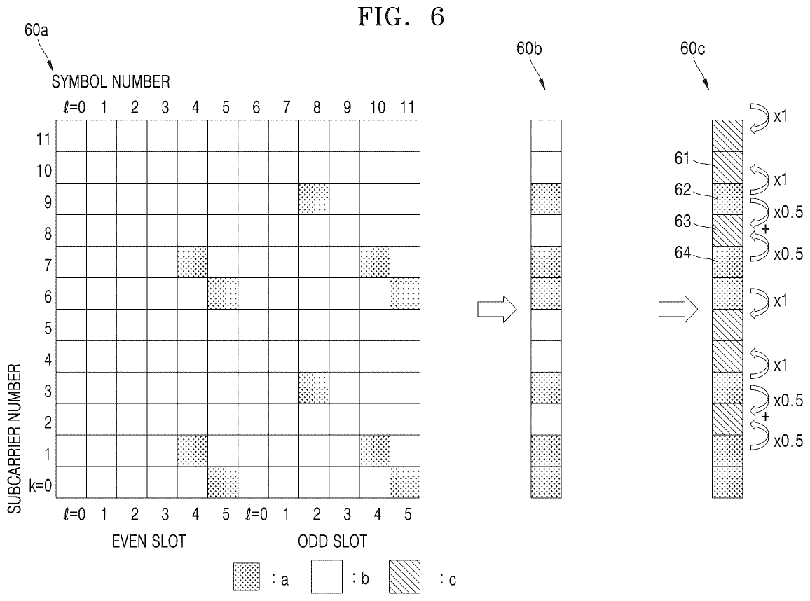

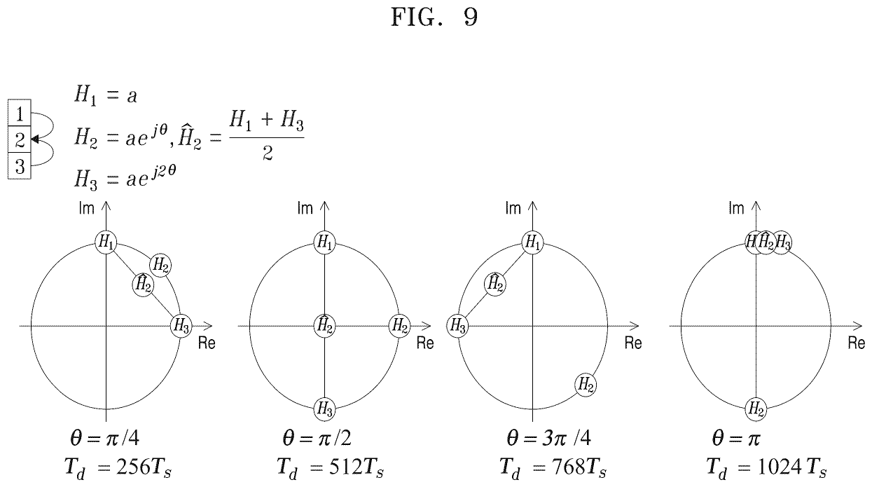

For example, a received signal may not be the PRS data. The user equipment 14 may receive the PRS data after the delayed interval D, and the PRS data may have a phase change in correspondence with the delayed interval D. When the PRS data has a phase change, interpolation for the PRS data (alternatively referred to as interpolation for the PRS) may undergo performance deterioration, and the user equipment 14 may not measure an accurate RSTD. The interpolation may refer to an operation of, on the basis of a time-domain or a frequency-domain, estimating a value for a resource element (RE) not allocated with a PRS of one symbol from a base station (for example, the first base station 11) based on an adjacent RE allocated with a PRS. The phase change of the PRS data is described below with reference to FIG. 9, and a specific example of the interpolation for the PRS data is described below with reference to FIG. 6.

The wireless communication system 100 according to an embodiment may receive a plurality of PRSs at the same timing to reduce an influence of the interference of a serving cell signal and, when there is a difference between a reception timing of a PRS and an actual arrival timing of the PRS, may perform a circular shift operation. Therefore, because the wireless communication system 100 may reduce the phase change of the PRS data while reducing an influence of the interference of a serving cell signal, the wireless communication system 100 may prevent the performance deterioration of the interpolation for the PRS data and may measure a relatively accurate RSTD.

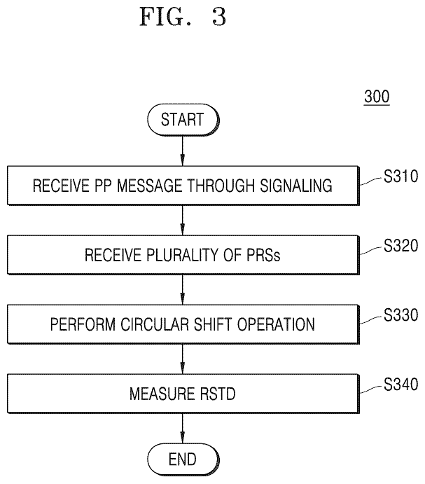

FIG. 3 is a flowchart illustrating an operation method of a user equipment, according to an embodiment. Referring to FIGS. 1 and 3, an operation method 300 of the user equipment 14 may include a plurality of operations S310 to S340.

In operation S310, the user equipment 14 may receive a Positioning Protocol (PP) message through signaling. For example, the user equipment 14 may receive the PP message from a serving cell (for example, the first base station 11) through signaling. The signaling may refer to a protocol responsible for radio resource management and control between the user equipment 14 and the serving cell (for example, the first base station 11), and the PP message may refer to a message for supporting various position estimation techniques, such as OTDoA or Enhanced Cell ID (E-CID). Although the PP message is described hereinafter as a LTE Positioning Protocol (LPP) message, embodiments are not limited thereto. For example, the PP message may include an LPP message, a New Radio Positioning Protocol A (NRPPa) message, or a protocol message defined in 3GPP.

In some embodiments, the user equipment 14 may perform wireless communication with the first base station 11, the signaling may include Radio Resource Control (RRC) signaling, and the PP message may be inserted as a payload of an RRC message and transmitted to the user equipment 14.

In operation S320, the user equipment 14 may receive a plurality of PRSs. In some embodiments, the user equipment 14 may receive a plurality of PRSs from several base stations at the same timing. The same timing may refer to the timing for a PRS of a serving cell (for example, the first base station 11) performing wireless communication with the user equipment 14, among the plurality of PRSs, to arrive at the user equipment 14. In some embodiments, the user equipment 14 may receive the plurality of PRSs during a period corresponding to a length of the PRS of the first base station starting from a first timing.

For example, the wireless communication system 100 may perform a positioning operation by using the OTDoA technique, and the user equipment 14 may receive a plurality of PRSs from a plurality of base stations, which include the first base station 11, the second base station 12, and the third base station 13, at the same timing, based on the received PP message.

Referring to FIG. 2, for example, the same timing may refer to the first timing T1, which is the timing for the PRS of the first base station 11 to arrive at the user equipment 14, and the user equipment 14 may receive the PRS of the first base station 11 at the first timing T1, and may receive the PRS of the second base station 12 at a time point from the first timing T1 until a third timing T1′ in correspondence with the length of the PRS of the first base station 11. For example, the user equipment 14 may calculate the first timing T1 based on PRS information (for example, a PRS pattern of the first base station 11, a PRS cycle of the first base station 11, and a subframe offset at which the PRS of the first base station 11 is transmitted) that is included in the PP message. For example, as illustrated in FIG. 2, the user equipment 14 may receive the PRS of the first base station 11 and the PRS of the second base station 12 during a period corresponding to a length of the PRS of the first base station 11 starting from the first timing T1. Here, the length of the PRS may be a difference between the third timing T1′ and the first timing T1.

Referring again to FIG. 3, in operation S330, the user equipment 14 may perform a circular shift operation. The circular shift operation may refer to an operation of changing a data starting position of a PRS.

In some embodiments, when there is a difference between the reception timing of a PRS and the actual arrival timing of the PRS, the user equipment 14 may perform the circular shift operation. For example, because the user equipment 14 receives the plurality of PRSs at the arrival timing of the PRS of the first base station 11, the user equipment 14 may not perform the circular shift operation on the PRS of the first base station 11.

For example, the user equipment 14 may receive the PRS of the second base station 12 for a period of time corresponding to the length of the PRS of the first base station 11 starting from the arrival timing of the PRS of the first base station 11 and may calculate the data starting position of the PRS of the second base station 12 based on an expected RSTD that is included in the PP message. The expected RSTD may refer to auxiliary information representing the difference in expected arrival time between a PRS of a serving cell (for example, the first base station 11) and a PRS of an adjacent cell (for example, the second base station 12). The user equipment 14 may change the calculated PRS data starting position to the timing at which the PRS of the first base station 11 arrives at the user equipment 14.

In operation S340, the user equipment 14 may measure an RSTD. In some embodiments, the user equipment 14 may generate a plurality of First Arrival Paths (FAPs) based on the plurality of PRSs received and may measure the RSTD based on the plurality of FAPs generated. The user equipment 14 may perform interpolation on the plurality of PRSs received, before generating the plurality of FAPs, and may generate the plurality of FAPs based on the PRSs having undergone the interpolation.

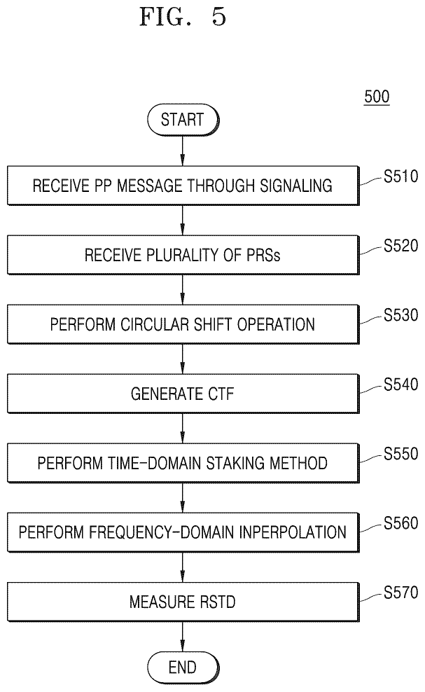

For example, the user equipment 14 may perform frequency-domain interpolation based on the received PRS of the first base station 11, and then, may generate a first FAP. The user equipment 14 may perform frequency-domain interpolation based on the PRS, which has undergone a circular shift operation, of the second base station 12, and then, may generate a second FAP. The user equipment 14 may measure the RSTD based on the first FAP and the second FAP. A specific example of measuring, by the user equipment 14, the RSTD is described below with reference to FIG. 5.

In the PRS of the second base station 12, which is received by the user equipment 14, although a reception timing at which the user equipment 14 starts to receive the PRS may be different from an arrival timing at which the PRS actually arrives at the user equipment 14, the user equipment 14 may perform the circular shift operation, and thus, may cause the reception timing and the arrival timing to be consistent with each other. Therefore, a data phase change of the PRS, which occurs in correspondence with the difference between the reception timing and the arrival timing, may be reduced, and the performance deterioration of the interpolation for the PRS of the second base station 12 may be prevented.

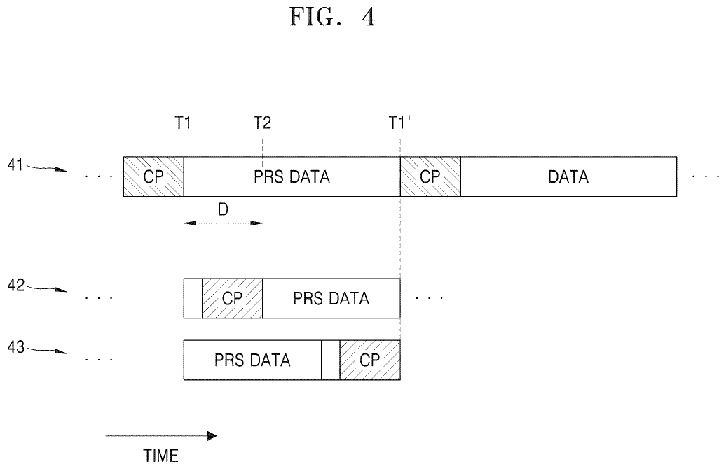

FIG. 4 is a diagram illustrating a circular shift operation of a user equipment, according to an embodiment. In some embodiments, a third signal 41 may be the same as the first signal 21 of FIG. 2, and a fourth signal 42 may be an example of the second signal 22 of FIG. 2. Repeated descriptions given with reference to FIG. 2 are omitted for conciseness.

Referring to FIGS. 1 and 4, the fourth signal 42 may refer to a signal of the second base station 12, which is received by the user equipment 14 from the first timing T1 until the third timing T1′ in correspondence with the length of the PRS of the first base station 11.

A fifth signal 43 may refer to a signal (alternatively referred to as data) which the user equipment 14 has generated by performing a circular shift operation based on the fourth signal 42. In some embodiments, the user equipment 14 may calculate the PRS data starting position of the PRS of the second base station 12, based on the expected RSTD in the PP message. For example, the user equipment 14 may calculate a second timing T2 as the PRS data starting position, based on the expected RSTD.

In some embodiments, the user equipment 14 may change the calculated PRS data starting position to the timing at which the PRS of the first base station 11 arrives at the user equipment 14. For example, the user equipment 14 may change the position of a portion of the fourth signal 42, which corresponds to a period from the second timing T2 until the third timing T1′, to the position before a portion of the fourth signal 42, which corresponds to the delayed interval D, thereby generating the fifth signal 43.

The user equipment 14 may perform frequency-domain interpolation based on the fifth signal 43. Because the timing at which the fifth signal 43 is received by the user equipment 14 may be consistent with the starting position of the PRS data so as to be the first timing T1, and the user equipment 14 may reduce a phase change of the PRS data, when the user equipment 14 performs frequency-domain interpolation, the performance deterioration of the frequency-domain interpolation may be prevented.

FIG. 5 is a flowchart illustrating an operation method of a user equipment, according to an embodiment. FIG. 6 is a diagram illustrating interpolation performed on a PRS by a user equipment, according to an embodiment. In some embodiments, an operation method 500 of the user equipment 14 may include a plurality of operations S510 to S570. Operations S510 and S520 may be respectively identical to operations S310 and S320 in FIG. 3, and repeated descriptions given with reference to FIG. 3 are omitted for conciseness.

Referring to FIGS. 1 and 5, in operation S530, the user equipment 14 may perform a circular shift operation. In some embodiments, the user equipment 14 may perform a circular shift operation based on data (or a signal) corresponding to at least one PRS. For example, the user equipment 14 may change a PRS data starting position of a signal (for example, the fourth signal 42 of FIG. 4) corresponding to the PRS of FIG. 4 to the first timing T1 of FIG. 4 and may generate the fifth signal 43 of FIG. 4.

In operation S540, the user equipment 14 may generate a Channel Transfer Function (CTF). For example, the user equipment 14 may generate the CTF by using Fast Fourier Transform (FFT) or Discrete Fourier Transform (DFT). The DFT may refer to a mathematical tool for decomposing a discrete time signal into frequency components, and the FFT may refer to an algorithm for calculating the DFT. The CTF may refer to a channel response in the frequency domain. In some embodiments, the user equipment 14 may generate a CTF by applying the FFT to data having undergone a circular shift operation. For example, because the user equipment 14 may perform a circular shift operation on the fourth signal 42 of FIG. 4 and may convert a reception signal into the frequency domain by using the FFT based on the fifth signal 43 having undergone the circular shift operation, and because the user equipment 14 may obtain information about a transmission signal based on the PP message, the user equipment 14 may generate the CTF based on the reception signal and the transmission signal.

When the CTF is generated by using the FFT based on the fourth signal 42 of FIG. 4 not having undergone the circular shift operation, the phase change of the fourth signal 42 of FIG. 4 may increase along with the increasing difference between a reception timing at which the user equipment 14 receives the fourth signal 42 of FIG. 4 and an arrival timing at which the PRS data of the fourth signal 42 of FIG. 4 actually arrives at the user equipment 14.

For example, Equation 1 shown below may represent an N×N DFT matrix (that is, W_{N}).

$$[ \begin{matrix}Y ( 0 ) \\ Y ( 1 ) \\ Y ( 2 ) \\ ⋮ \\ Y ( k )\end{matrix} ] = [ \begin{matrix}1 & 1 & … & 1 \\ 1 & {e}^{\frac{- 2 π i}{N}} & … & {e}^{\frac{- 2 π i}{N} ( N - 1 )} \\ 1 & \text{?} & … & \text{?} \\ ⋮ & ⋮ & ⋱ & ⋮ \\ 1 & \text{?} & … & \text{?}\end{matrix} ] [ \begin{matrix}y ( 0 ) \\ y ( 1 ) \\ y ( 2 ) \\ ⋮ \\ y ( n )\end{matrix} ] \qquad [ Equation 1 ]$$

$$\text{?} \text{indicates text missing or illegible when filed}$$

Equation 1 may include a time-domain vector y=[y(0), y(1), . . . , y(N−1)]^{T},

$${[ {W}_{N} ]}_{k , n} = {e}^{- j \frac{2 π}{N} kn} ,$$

and a frequency-domain vector Y=[Y(0), Y(1), . . . , Y(N−1)]^{T}. The numbers k and n may each denote an integer of 0 to N−1. It may be confirmed that, as the column index of the N×N DFT matrix (that is, W_{N}) increases, the phase difference (or change) between Y(k) increases. A starting point of an FFT window may be a reception timing of a PRS, and as the difference between the reception timing and a data arrival timing of the PRS increases, the phase difference (or change) between REs may be mapped to a large DFT vector. When the phase difference (or change) between REs is large, the performance deterioration of interpolation may occur. Therefore, the user equipment 14 according to an embodiment may perform the circular shift operation before generating the CTF by using the FFT and may reduce the phase difference (or change) between adjacent REs.

In operation S550, the user equipment 14 may perform a time-domain staking method. In some embodiments, the user equipment 14 may generate data (or a signal) corresponding to one symbol by performing the time-domain staking method.

Referring to FIG. 6, a first grid 60a may represent an example in which a PRS is mapped to two RBs. There may be various examples in which a PRS is mapped to RBs. The first grid 60a may correspond to the PRS of the second base station 12. In the first grid 60a, two PRSs may be mapped to one symbol, a PRS-mapped RE may be referred to as a first RE(a), and a non-PRS-mapped RE may be referred to as a second RE(b). When an RSTD is measured based on one symbol, because a frequency sampling rate is low, it may be difficult to measure an accurate RSTD. Because a PRS is transmitted to different RE positions across several symbols, estimating the second RE(b), which is not PRS-mapped, as an adjacent first RE(a) on the basis of the time domain may be referred to as the time-domain staking method.

For example, the user equipment 14 may perform the time-domain staking method on a second RB (for example, an RB corresponding to a symbol number of 6 to 11) out of two RBs across several symbols, thereby generating first data 60b corresponding to one symbol. The first data 60b may correspond to the CTF generated by applying the FFT to the fifth signal 43 of FIG. 4.

Referring again to FIG. 5, in operation S560, the user equipment 14 may perform frequency-domain interpolation. In some embodiments, the user equipment 14 may generate data (or a signal) corresponding to one symbol by performing the frequency-domain interpolation based on the CTF.

Referring again to FIG. 6, in operation S540, the user equipment 14 may generate the CTF having a value corresponding to a subcarrier allocated with a PRS, based on the fifth signal 43 of FIG. 4. Due to an RE (for example, the second RE(b)) corresponding to a subcarrier not allocated with a PRS, there may be periodic discontinuity in the CTF. An operation of generating the CTF having undergone the removal of discontinuity by adding a weighted value to a CTF value corresponding to a subcarrier allocated with a PRS (for example, a CTF value corresponding to the first RE(a)) on the basis of the same symbol may be referred to as the frequency-domain interpolation.

For example, the user equipment 14 may set a first CTF value 61 corresponding to a subcarrier allocated with no PRS to a second CTF value 62 corresponding to an adjacent subcarrier allocated with a PRS.

For example, the user equipment 14 may set a third CTF value 63 corresponding to a subcarrier allocated with no PRS to an average value of the second CTF value 62 and a fourth CTF value 64, which respectively correspond to two adjacent subcarriers allocated with PRSs.

For example, the user equipment 14 may set a CTF value corresponding to a subcarrier allocated with no PRS to a CTF value c by adding a weighted value to at least one CTF value corresponding to an adjacent subcarrier allocated with a PRS, and may generate second data 60c based on the CTF value c.

Referring again to FIG. 5, in operation S570, the user equipment 14 may measure an RSTD. In some embodiments, the user equipment 14 may generate an FAP based on the CTF and may measure the RSTD based on the FAP. For example, the user equipment 14 may generate a Channel Impulse Response (CIR) based on the second data 60c and may generate the FAP based on the FAP. The CIR may refer to a value generated by applying Inverse Discrete Fourier Transform (IDFT) or Inverse Fast Fourier Transform (IFFT) to the CTF, and the FAP may refer to a peak position of the CIR.

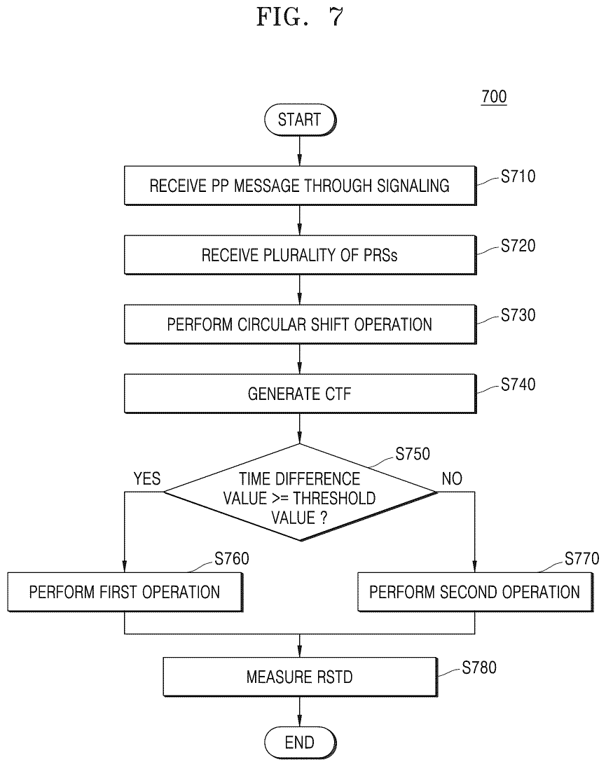

FIG. 7 is a flowchart illustrating an operation method of a user equipment, according to an embodiment. In some embodiments, an operation method 700 of the user equipment 14 may include a plurality of operations S710 to S790. Operations S710 to S740 may be respectively identical to operations S510 to S540 in FIG. 5, and repeated descriptions given with reference to FIG. 5 are omitted for conciseness.

Referring to FIGS. 1 and 7, in operation S750, the user equipment 14 may determine whether a time difference value is greater than or equal to a threshold value. For example, the user equipment 14 may compare the time difference value with the threshold value to determine whether the time difference value is greater than or equal to the threshold value. The time difference value may refer to a difference value (for example, the delayed interval D) between a timing (for example, the first timing T1 in FIG. 4) at which the user equipment 14 receives a PRS and a timing (for example, the second timing T2 in FIG. 4) at which data of the PRS arrives at the user equipment 14. The threshold value may refer to a preset particular value.

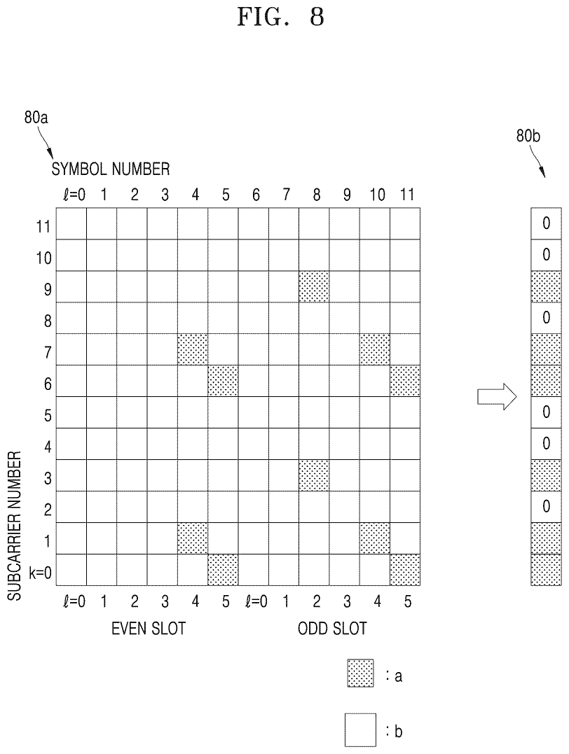

In some embodiments, when a result of the comparing in operation S750 indicates that the time difference value is greater than or equal to the threshold value (S750, YES), the user equipment 14 may perform a first operation in operation S760. The first operation may refer to an operation of generating data (or a signal) by setting a CTF value, which corresponds to a subcarrier allocated with no PRS, in the CTF to 0. A specific example of the first operation is described below with reference to FIG. 8.

In some embodiments, when the result of the comparing in operation S750 indicates that the time difference value is less than the threshold value (S750, NO), a second operation may be performed in operation S770. The second operation may be the same as operations S550 and S560 in FIG. 5.

In some embodiments, the user equipment 14 may calculate the time difference value based on an expected RSTD that is included in a PP message. For example, the user equipment 14 may calculate the first timing T1 in FIG. 4 based on PP information that is included in the PP message, and may calculate the second timing T2 in FIG. 4 based on the expected RSTD. The user equipment 14 may calculate the time difference value based on the calculated timings.

In operation S780, the user equipment 14 may measure an RSTD. In some embodiments, the RSTD may be measured based on the data generated by performing the first operation in operation S760 or the data generated by performing the second operation in operation S770.

FIGS. 8 to 10 are diagrams illustrating a second operation of a user equipment, according to an embodiment. In some embodiments, a second grid 80a of FIG. 8 may be the same as the first grid 60a of FIG. 6. Repeated descriptions given with reference to FIG. 6 are omitted for conciseness.

Referring to FIG. 8, the user equipment 14 may perform operations S720 to S740 based on the second grid 80a and may generate data (for example, the first data 60b of FIG. 6). In some embodiments, when the result of the comparing indicates that the time difference value is greater than or equal to the threshold value, the user equipment 14 may generate a CTF by performing operation S740 and may generate data (for example, the first data 60b of FIG. 6) by using the time-domain staking method. In the data (for example, the first data 60b of FIG. 6), a CTF value allocated with no PRS may be set to 0.

For example, the user equipment 14 may set a CTF value corresponding to the second RE(b) allocated with no PRS, in the second grid 80a, to 0 instead of estimating the CTF value corresponding to the second RE(b) allocated with no PRS as a CTF value corresponding to an adjacent first RE(a) allocated with a PRS, thereby generating third data 80b.

Referring to FIG. 9, H₂ may refer to an ideal channel value, and H₁ and H₃, which are adjacent to H₂, may refer to channel values allocated with PRSs. Ĥ may refer to a channel value estimated based on H₁ and H₃ (for example, a channel value estimated by performing the second operation of FIG. 7). T_{d} may refer to the time difference value of FIG. 7, and Tₛ may refer to a value defined in standards. For example, Tₛ may be 1/(15000*2048) [sec], and 2048*Tₛ may correspond to the length of one symbol.

It may be confirmed that, although the ideal channel value is similar to the estimated channel value in the case where the time difference value T_{d} is 256*Tₛ, the case where the time difference value T_{d} is 512*Tₛ is the same as the case where the estimated channel value is set to 0, and there is a significant error between the ideal channel value and the estimated channel value in the case where the time difference value T_{d} is each of 768*Tₛ and 1024*Tₛ.

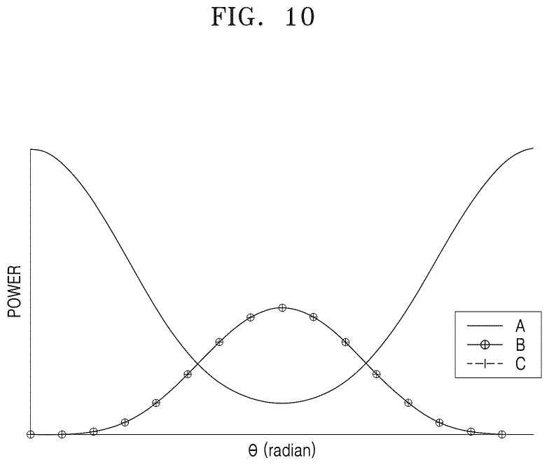

Referring to FIG. 10, the graph of FIG. 10 may be a graph for finding a peak value of a CIR. The horizontal axis may represent a phase, and the vertical axis may represent power. A first path A may indicate an actual path of the CIR, and a second path B and a third path C may each indicate an error path detected because there is an error between the ideal channel value and the estimated channel value due to the time difference value Ta. The phase may increase as the time difference value T_{d} increases, and when the phase is equal to or greater than 2*π/3 (or ⅓ of the symbol length), because a power value of the error path is measured higher than a power value of the actual path, the error path may be generated as an FAP.

In other words, when the time difference value T_{d} is greater than or equal to a particular value (for example, the threshold value), the error between the ideal channel value and the estimated channel value may be relatively large, and thus, the error path may be generated as the FAP. The user equipment 14 according to an embodiment may set the estimated channel value to 0 when the time difference value T_{d} is equal to or greater than the threshold value (for example, ⅓ of the symbol length), and may reduce an error due to the time difference value T_{d}.

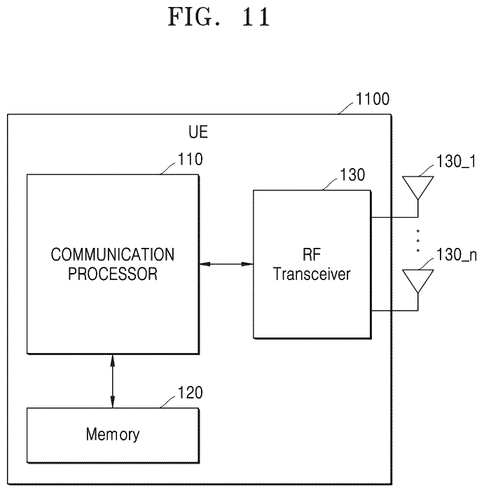

FIG. 11 is a block diagram illustrating a user equipment according to an embodiment. An implementation example of a user equipment 1100 of FIG. 11 may be applied to the user equipment 14 of FIG. 1.

The user equipment 1100 may include a communication processor 110, a memory 120, a radio frequency (RF) transceiver 130, and a plurality of antennas 130_1 to 130_n. The RF transceiver 130 may receive RF signals, which are transmitted by the first base station 11 of FIG. 1, via the antennas 130_1 to 130_n. For example, the RF transceiver 130 may receive a PP message from the first base station 11 of FIG. 1 through signaling. The RF transceiver 130 may generate intermediate-frequency or baseband signals by down-converting the received RF signals. The RF transceiver 130 may up-convert intermediate-frequency or baseband signals, which are output from the communication processor 110, and may transmit the up-converted signals as RF signals via the antennas 130_1 to 130_n.

The communication processor 110 may generate data signals by filtering, decoding, and/or digitizing intermediate-frequency or baseband signals and may receive data signals from the RF transceiver 130. The communication processor 110 may encode, multiplex, and/or analog-convert the received data signals. The communication processor 110 may additionally process data signals and, to perform all control operations on the user equipment 1100, may execute a program stored in the memory 120 and/or a process.

In some embodiments, the communication processor 110 may be configured to receive a plurality of PRSs at the same timing based on the PP message received from the first base station 11 of FIG. 1 and perform a circular shift operation on a PRS, which has a difference between the reception timing and the arrival timing thereof, among the plurality of PRSs. In some embodiments, the communication processor 110 may be configured to receive the plurality of PRSs during a period corresponding to a length of the PRS of the first base station starting from a first timing.

For example, the communication processor 110 may receive the PRS of the first base station 11 of FIG. 1 and the PRS of the second base station 12 of FIG. 1 at a reception timing (for example, the first timing T1 of FIG. 4) at which the PRS of the first base station 11 of FIG. 1 arrives at the user equipment 1100, and may perform a circular shift operation for changing a starting position of PRS data of the PRS of the second base station 12 to the reception timing. Specifically, the communication processor 110 may receive the PRS of the first base station 11 and the PRS of the second base station 12 during a period corresponding to a length of the PRS of the first base station 11 starting from the first timing T1, and the length of the PRS may be a difference between the third timing T1′ and the first timing T1.

In some embodiments, the communication processor 110 may be configured to measure an RSTD based on the plurality of PRSs including the PRS having undergone the circular shift operation.

For example, the communication processor 110 may generate a CTF by using the FFT, based on the PRS of the first base station 11 and the PRS, which has undergone the circular shift operation, of the second base station 12, and may generate an FAP based on the CTF, thereby measuring the RSTD.

The memory 120 may have any structure for storing data. For example, the memory 120 may include a volatile memory device, such as dynamic random-access memory (DRAM) or static random-access memory (SRAM), or may include a nonvolatile memory device, such as flash memory or resistive random-access memory (RRAM).

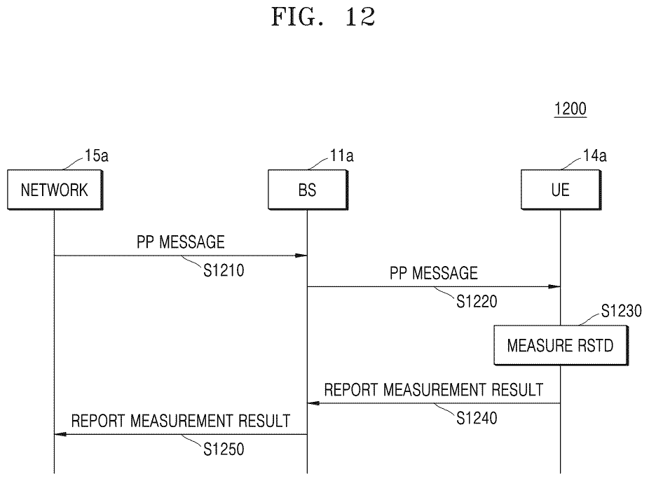

FIG. 12 is a flowchart illustrating an operation method of a wireless communication system, according to an embodiment. Referring to FIG. 12, an operation method 1200 of a wireless communication system (for example, the wireless communication system 100 of FIG. 1) may include a plurality of operations S1210 to S1250. A base station 11a may be an example of the first base station 11 of FIG. 1, and a user equipment 14a may be an example of the user equipment 14 of FIG. 1. Repeated descriptions given with reference to FIG. 1 are omitted for conciseness. A network 15a may refer to an LMF (for example, a location server).

In operation S1210, the network 15a may transmit a PP message to the base station 11a. In some embodiments, the network 15a may generate pieces of information (for example, the PP message) used to estimate the position of the user equipment 14a and may transmit the generated pieces of information to the base station 11a.

In operation S1220, the base station 11a may transmit the PP message, which is received from the network 15a, to the user equipment 14a through signaling. Operation S1220 may be an example of operation S310 of FIG. 3, and repeated descriptions thereof are omitted for conciseness.

In operation S1230, the user equipment 14a may measure an RSTD based on the received PP message. In some embodiments, the user equipment 14a may receive PRSs of a plurality of base stations, which include the base station 11a and at least one base station adjacent to the base station 11a, based on the PP message.

In some embodiments, the user equipment 14a may operate in a first mode or a second mode. For example, the user equipment 14a may operate in the first mode when a time difference value (which is the same as the time difference value described with reference to FIG. 7) is less than a threshold value, and may operate in the second mode when the time difference value is greater than or equal to the threshold value. The threshold value may refer to a preset particular value. In an embodiment, the threshold value may refer to a value set to ½ of the symbol length.

When operating in the first mode, the user equipment 14a may operate in the same manner as at least one of the operation method 300 of FIG. 3, the operation method 500 of FIG. 5, and the operation method 700 of FIG. 7.

When operating in the second mode, the user equipment 14a may receive a plurality of PRSs at different timings. For example, the user equipment 14a may receive a PRS of a first base station at a timing (for example, the first timing T1 of FIG. 4) at the PRS of the first base station arrives, and may receive a PRS of a second base station at a timing (for example, the second timing T2 of FIG. 4) at the PRS of the second base station arrives. The user equipment 14a may measure the RSTD based on the PRSs received at the different timings.

In operation S1240, the user equipment 14a may report a measurement result to the base station 11a. In some embodiments, the measurement result may refer to the RSTD measured based on the plurality of PRSs received by the user equipment 14a. In some embodiments, the measurement result may refer to the position of the user equipment 14a, which is estimated by triangulation or a similar principle thereto, based on the RSTD measured by the user equipment 14a.

In operation S1250, the base station 11a may report the measurement result to the network 15a. In some embodiments, when the measurement result is the measured RSTD, the network 15a may estimate the position of the user equipment 14a by triangulation or a similar principle thereto, based on the received RSTD. In some embodiments, when the measurement result is the position of the user equipment 14a, the network 15a may store the measurement result.

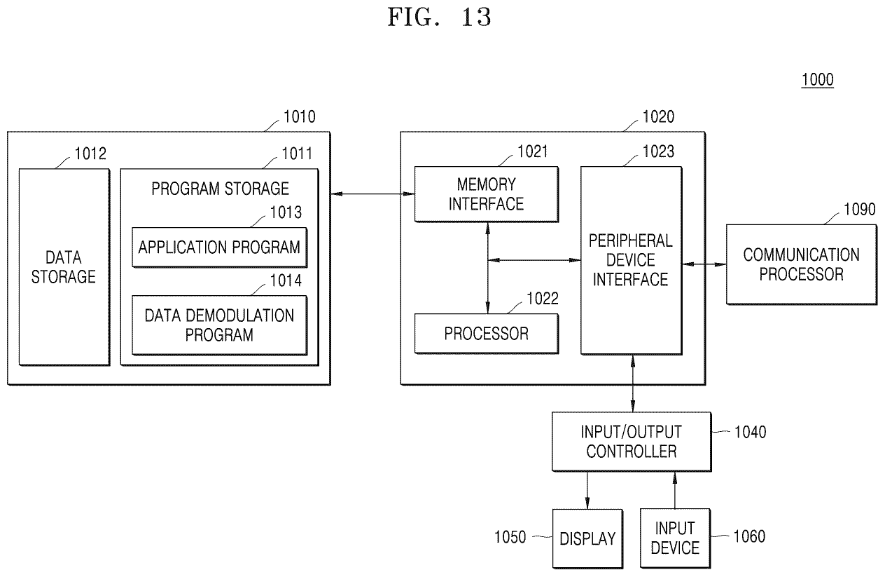

FIG. 13 is a block diagram illustrating an electronic device according to an embodiment. An electronic device 1000 may include, but is not limited to, a user equipment according to an embodiment. For example, the electronic device 1000 may include a device for communicating with an external network (for example, the base stations 11, 12, and 13 of FIG. 1 or an external server) or may include an autonomous driving vehicle, a robot, or the like.

Referring to FIG. 13, the electronic device 1000 may include a memory 1010, a processor circuit 1020, an input/output controller 1040, a display 1050, an input device 1060, and a communication processor 1090. Here, the memory 1010 may be provided in a plural number. Descriptions of the respective components may be made as follows.

The memory 1010 may include a program storage 1011 that stores a program for controlling operations of the electronic device 1000 and a data storage 1012 that stores data generated during the execution of the program. The data storage 1012 may store data for operations of an application program 1013 and a data demodulation program 1014 or may store data generated from the operations of the application program 1013 and the data demodulation program 1014.

The program storage 1011 may include the application program 1013 and the data demodulation program 1014. Here, the program in the program storage 1011 may be a set of instructions and may be referred to as an instruction set. The application program 1013 may include pieces of program code for performing various applications that operate on the electronic device 1000. That is, the application program 1013 may include pieces of code (or commands) regarding various applications driven by a processor 1022.

The electronic device 1000 may include the communication processor 1090 configured to perform a communication function for speech communication and data communication. A peripheral device interface 1023 may control connections between the input/output controller 1040, the communication processor 1090, the processor 1022, and a memory interface 1021. By using at least one software program, the processor 1022 controls a plurality of base stations to provide a service corresponding to the software program. Here, by executing at least one program stored in the memory 1010, the processor 1022 may provide a service corresponding to the program.

In some embodiments, the processor 1022 may be configured to receive a plurality of PRSs at the same timing, based on a PP message received from the first base station 11 of FIG. 1, and perform a circular shift operation on a PRS, which has a difference between the reception timing and the arrival timing thereof, among the plurality of PRSs.

For example, the processor 1022 may receive the PRS of the first base station 11 of FIG. 1 and the PRS of the second base station 12 of FIG. 1 at a reception timing (for example, the first timing T1 of FIG. 4) at which the PRS of the first base station 11 of FIG. 1 arrives at the user equipment 1100, and may perform a circular shift operation for changing a starting position of PRS data of the PRS of the second base station 12 to the reception timing.

In some embodiments, the processor 1022 may be configured to measure an RSTD based on the plurality of PRSs including the PRS having undergone the circular shift operation.

For example, the processor 1022 may generate a CTF by using the FFT, based on the PRS of the first base station 11 and the PRS, which has undergone the circular shift operation, of the second base station 12, and may generate an FAP based on the CTF, thereby measuring the RSTD.

The input/output controller 1040 may provide an interface between input/output devices, such as the display 1050 and the input device 1060, and the peripheral device interface 1023. The display 1050 displays state information, input characters, moving pictures, still pictures, and the like. For example, the display 1050 may display application information regarding applications driven by the processor 1022.

The input device 1060 may provide input data generated through selection by the electronic device 1000 to the processor circuit 1020 via the input/output controller 1040. Here, the input device 1060 may include a keypad including at least one hardware button, a touchpad for sensing touch information, and the like. For example, the input device 1060 may provide the touch information, such as a touch, a touch motion, or a touch release, which is sensed by the touchpad, to the processor 1022 via the input/output control unit 1040.

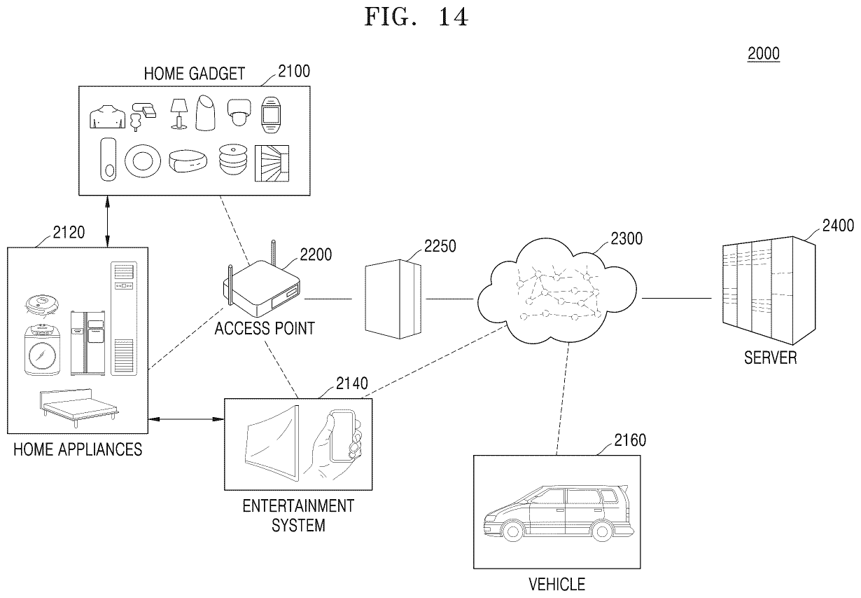

FIG. 14 is a conceptual diagram illustrating an Internet-of-Things (IoT) network system to which an embodiment is applied.

Referring to FIG. 14, an IoT network system 2000 may include a plurality of IoT devices, an access point 2200, a gateway 2250, a wireless network 2300, and a server 2400. The IoT devices may include one or more home gadgets, one or more home appliances, one or more entertainment systems, and/or one or more vehicles. IoT may refer to a network between things using wired/wireless communication.

The IoT devices may be grouped to form groups, depending on characteristics of each IoT device. For example, the IoT devices may be grouped into a home gadget group 2100, a home appliance/furniture group 2120, an entertainment group 2140, a vehicle group 2160, or the like. A plurality of IT devices may be connected to a communication network or another IoT device via the access point 2200. The access point 2200 may be embedded in one IoT device. The gateway 2250 may change a protocol such that the access point 2200 is connected to an external wireless network. The IoT devices may be connected to the external communication network via the gateway 2250. The wireless network 2300 may include the Internet and/or a public network. The plurality of IoT devices may be connected, via the wireless network 2300, to the server 2400 providing a certain service, and a user may use the service via at least one of the plurality of IoT devices.

In some embodiments, each of the plurality of IoT devices (for example, each home gadget, each home appliance, each entertainment system, each vehicle, etc.) may be configured to receive a plurality of PRSs at the same timing, based on a PP message received from the first base station 11 of FIG. 1, and perform a circular shift operation on a PRS, which has a difference between the reception timing and the arrival timing thereof, among the plurality of PRSs.

For example, each of the plurality of IoT devices may receive the PRS of the first base station 11 of FIG. 1 and the PRS of the second base station 12 of FIG. 1 at a reception timing (for example, the first timing T1 of FIG. 4) at which the PRS of the first base station 11 of FIG. 1 arrives at each of the plurality of IoT devices (that is, 2100, 2120, 2140, and 2160), and may perform a circular shift operation for changing a starting position of PRS data of the PRS of the second base station 12 to the reception timing.

In some embodiments, each of the plurality of IoT devices may be configured to measure an RSTD based on the plurality of PRSs including the PRS having undergone the circular shift operation.

For example, each of the plurality of IoT devices may generate a CTF by using the FFT, based on the PRS of the first base station 11 and the PRS, which has undergone the circular shift operation, of the second base station 12, and may generate an FAP based on the CTF, thereby measuring the RSTD.

Heretofore, various embodiments been particularly shown and described with reference to the accompanying drawings. Although the embodiments have been described herein by using particular terms, these terms used herein are only for describing the embodiments and are not intended to limit the scope of the present disclosure, which is defined by the appended claims. Therefore, it will be understood by those of ordinary skill in the art that there may be various modifications and equivalent embodiments made from the embodiments described herein. Therefore, the scope of the present disclosure should be defined by the appended claims.

What is claimed is:

1. An operation method of a user equipment configured to perform wireless communication with a first base station, the operation method comprising:
receiving a Positioning Protocol (PP) message from the first base station through signaling;
receiving, based on the PP message, a Positioning Reference Signal (PRS) of the first base station from the first base station at a first timing and a PRS of a second base station that is adjacent to the first base station;
generating first data by performing a circular shift operation that changes a starting position of PRS data of the PRS of the second base station, to the first timing; and
measuring a Reference Signal Time Difference (RSTD) based on the PRS of the first base station and the first data,
wherein the first timing is a timing at which the PRS of the first base station arrives at the user equipment.

2. The operation method of claim 1, wherein:
the PP message includes an expected RSTD, which is a difference in an expected arrival time between the PRS of the first base station and the PRS of the second base station, and
the starting position of the PRS data is calculated based on the expected RSTD.

3. The operation method of claim 1, wherein measuring the RSTD comprises:
generating a first Channel Transfer Function (CTF) by using a Fast Fourier Transform (FFT), based on the first data; and
generating a second CTF corresponding to one symbol by performing a time-domain staking method on the first CTF based on a plurality of pieces of PRS data, which are included in the PRS of the second base station.

4. The operation method of claim 3, wherein measuring the RSTD further comprises:
when a time difference value is greater than or equal to a first threshold value, generating third data by setting, in the second CTF, a CTF value to which the PRS of the second base station is not allocated in the first data to 0;
generating a First Arrival Path (FAP) corresponding to the third data, based on the third data; and
measuring the RSTD based on the PRS of the first base station and the FAP corresponding to the third data, and
wherein the time difference value includes a difference value between the first timing and a second timing at which the PRS of the second base station arrives at the user equipment.

5. The operation method of claim 4, wherein:
the PP message includes an expected RSTD, which is a difference in an expected arrival time between the PRS of the first base station and the PRS of the second base station, and
the second timing is calculated based on the expected RSTD.

6. The operation method of claim 4, wherein the first threshold value is ⅓ of a length of one symbol.

7. The operation method of claim 3, wherein measuring the RSTD comprises:
generating second data by performing frequency-domain interpolation based on the second CTF;
generating a First Arrival Path (FAP) corresponding to the second data, based on the second data; and
measuring the RSTD based on the PRS of the first base station and the FAP corresponding to the second data.

8. The operation method of claim 7, wherein the frequency-domain interpolation comprises:
setting a CTF value, which corresponds to a subcarrier not allocated with the PRS of the second base station, to an average value of CTF values corresponding to two adjacent subcarriers allocated with the PRS of the second base station.

9. The operation method of claim 7, wherein the frequency-domain interpolation comprises:
setting a CTF value, which corresponds to a subcarrier not allocated with the PRS of the second base station, to a CTF value corresponding to an adjacent subcarrier allocated with the PRS of the second base station.

10. The operation method of claim 1, wherein the receiving comprises:
when a difference value between a second timing at which the PRS of the second base station arrives at the user equipment and the first timing is greater than or equal to a second threshold value, receiving the PRS of the first base station at the first timing and receiving the PRS of the second base station at the second timing.

11. The operation method of claim 10, wherein the second threshold value is ½ of a length of one symbol.

12. A user equipment configured to perform wireless communication with a first base station, the user equipment comprising:
a plurality of antennas configured to receive a Positioning Protocol (PP) message from the first base station through signaling; and
a communication processor configured to measure a Reference Signal Time Difference (RSTD) based on the PP message,
wherein the communication processor is further configured to:
when operating in a first mode, receive a Positioning Reference Signal (PRS) of the first base station at a first timing that is a timing at which the PRS of the first base station arrives at the user equipment, and a PRS of a second base station that is adjacent to the first base station; generate first data by performing a circular shift operation that changes a starting position of PRS data of the PRS of the second base station to the first timing; and measure the RSTD based on the PRS of the first base station and the first data; and
when operating in a second mode, receive the PRS of the first base station at the first timing, receive the PRS of the second base station at a second timing at which the PRS of the second base station arrives at the user equipment, and measure the RSTD based on the PRS of the first base station and the PRS of the second base station.

13. The user equipment of claim 12, wherein the communication processor is further configured to:
when operating in the first mode, generate a first Channel Transfer Function (CTF) by using a Fast Fourier Transform (FFT) based on the first data; generate a second CTF corresponding to one symbol by performing a time-domain staking method on the first CTF based on a plurality of pieces of PRS data of the PRS of the second base station; and measure the RSTD based on a comparison result obtained by comparing a time difference value with a first threshold value, and
wherein the time difference value includes a difference value between the second timing and the first timing.

14. The user equipment of claim 13, wherein the communication processor is further configured to:
when the comparison result indicates that the time difference value is greater than or equal to the first threshold value, generate third data by setting a second CTF value, which is not allocated with the PRS of the second base station in the first data, in the second CTF to 0, and measure the RSTD based on the third data and the PRS of the first base station; and
when the comparison result indicates that the time difference value is less than the first threshold value, generate second data by performing frequency-domain interpolation based on the second CTF, and measure the RSTD based on the second data and the PRS of the first base station.

15. The user equipment of claim 14, wherein the first threshold value is ⅓ of a length of one symbol, and
wherein the frequency-domain interpolation comprises setting a CTF value, which corresponds to a subcarrier not allocated with the PRS of the second base station, to an average value of CTF values corresponding to two adjacent subcarriers allocated with the PRS of the second base station.

16. The user equipment of claim 12, wherein:
the communication processor is further configured to operate in the second mode when a time difference value is greater than or equal to a second threshold value; and operate in the first mode when the time difference value is less than the second threshold value,
the time difference value is a difference value between the second timing and the first timing, and
the second threshold value is ½ of a length of one symbol.

17. The user equipment of claim 12, wherein the communication processor is further configured to calculate a position of the user equipment based on the RSTD.

18. A user equipment configured to perform wireless communication with a first base station, the user equipment comprising:
a plurality of antennas configured to receive a Positioning Protocol (PP) message from the first base station through signaling; and
a communication processor configured to measure a Reference Signal Time Difference (RSTD) based on the PP message,
wherein the communication processor is further configured to receive, based on the PP message, a Positioning Reference Signal (PRS) of the first base station at a first timing and a PRS of a second base station adjacent to the first base station; generate first data by performing a circular shift operation that changes a starting position of PRS data of the PRS of the second base station to the first timing; and measure the RSTD based on the PRS of the first base station and the first data, and
wherein the first timing is a timing at which the PRS of the first base station arrives at the user equipment.

19. The user equipment of claim 18, wherein the communication processor is further configured to:
generate a first Channel Transfer Function (CTF) by using an Fast Fourier Transform (FFT) based on the first data; generate a second CTF corresponding to one symbol by performing a time-domain staking method based on a plurality of pieces of PRS data of the PRS of the second base station; and measure the RSTD based on a comparison result obtained by comparing a time difference value with a first threshold value.

20. The user equipment of claim 19, wherein the communication processor is further configured to:
when the comparison result indicates that the time difference value is greater than or equal to the first threshold value, generate third data by setting a second CTF value, which is not allocated with the PRS of the second base station in the first data, in the second CTF to 0, and measure the RSTD based on the third data and the PRS of the first base station; and
when the comparison result indicates that the time difference value is less than the first threshold value, generate second data by performing frequency-domain interpolation based on the second CTF, and measure the RSTD based on the second data and the PRS of the first base station.
